(19) United States
(12) Patent Application Publication
(10) Pub. No.: US 2020/0361102 A1
(43) Pub. Date: Nov. 19, 2020

(54) CONVERTIBLE KNIFE

(71) Applicant: Alan SCHUSTER, Rockaway Park, NY (US)

(72) Inventor: Alan SCHUSTER, Rockaway Park, NY (US)

(21) Appl. No.: 16/542,492

(22) Filed: Aug. 16, 2019

Related U.S. Application Data
(63) Continuation-in-part of application No. 15/623,778, filed on Jun. 15, 2017, now Pat. No. 10,421,200.
(60) Provisional application No. 62/350,817, filed on Jun. 16, 2016.

(51) Int. Cl. B26B 1/00

(52) U.S. Cl. CPC B26B 1/00

(57) ABSTRACT

A knife is provided having both a multi-blade configuration for cutting multiple slices simultaneously as well as a single blade configuration for storage and single cuts. In some embodiments, the multiple blade configuration may be adjustable to define varying distances between the multiple blades.

### CROSS REFERENCE TO RELATED APPLICATION

This present application is a Continuation in Part from U.S. patent application Ser. No. 15/623,778, filed Jun. 15, 2017, which takes priority from Provisional Patent Application 62/350,817, filed Jun. 16, 2016, the entire contents of which are incorporated herein by reference.

### FIELD OF THE INVENTION

The invention relates to a knife that can convert from a first configuration to a second configuration.

### BACKGROUND

Knives are often used to cut multiple slices of substances, such as food. Typically, a knife must be used to cut each individual slice by using repeated slicing motions. This activity is time consuming, tedious, and potentially dangerous for people without much experience.

While some multi-blade choppers exist, allowing for multiple simultaneous slices of food, they are typically clunky and difficult to handle. Further, they are difficult to store, since they do not fit in traditional knife blocks, and impossible to use when only a single, more precise, cut is needed. Further, such choppers lack adjustments, so that if a user wishes to vary the spacing between slices of food, they must use a single knife instead of such a chopper.

There is a need for a single knife that can be used in either a multi-blade configuration for cutting multiple slices simultaneously or a single blade configuration for storage and for more precise cuts.

### SUMMARY

A knife is provided having both a multi-blade configuration for cutting multiple slices simultaneously as well as a single blade configuration for storage and single cuts. In some embodiments, the multiple blade configuration may be adjustable to define varying distances between the multiple blades.

Such a knife may comprise a handle and a plurality of individual blades movably fixed to the handle, where the plurality of individual blades has a first configuration, where the blades are in distinct planes. The plurality of individual blades may have a second configuration, wherein the plurality of individual blades are substantially coplanar and form a combined blade.

The distinct planes of the individual blades in the first configuration may be parallel and may be spaced apart, and the individual blades, or segments thereof, may be coextensive when the blades form a combined blade on the second configuration. In such a configuration, a total width of the combined blade would typically be less than the combined widths of the individual blades.

The individual blades typically each have a knife edge at a first edge of the blade, and at least one of the individual blades would have a seat for retaining the knife edge at a second edge of the blade. Accordingly, when the blades are coplanar, the knife edge from one of the plurality of blades may sit in a seat of a second of the plurality of blades.

When the individual blades are in the first configuration, they may be translatable relative to each other, such that the amount by which the distinct planes are spaced apart is adjustable.

Typically, the blades may be transitioned from the first configuration to the second configuration by rotating each blade about a respective rotational axis running the length of the corresponding blade. The handle may have a length extending in parallel with the rotational axes of the individual blades.

In an alternative chopper embodiment, the handle may extend in a direction perpendicular to the rotational axes of the blades.

In some embodiments, the rotational axes of the individual blades translate relative to each other during the transition from the first configuration to the second configuration.

### BRIEF DESCRIPTION OF THE DRAWINGS

FIG. 1 shows a first view of a knife in a first configuration;

FIG. 2 shows a first view of the knife of FIG. 1 in a second configuration;

FIG. 3 shows a second view of the knife of FIG. 1 in the second configuration;

FIGS. 4A-4B show the knife of FIG. 1 in a third configuration;

FIG. 5 shows the knife of FIG. 1 with its housing removed;

FIG. 6 shows an exploded view of the knife of FIG. 1;

FIGS. 7A-7B show detailed views of an embodiment of a knife in the first configuration.

FIG. 8 show a detail of a second embodiment of a knife in the first configuration.

FIGS. 9A-9C show a second embodiment of a knife in a first configuration in accordance with this disclosure.

FIGS. 10A-10B show the knife of FIG. 9A in a second configuration.

FIGS. 11A-11C show the knife of FIG. 9A in a third configuration.

FIGS. 12A-12C show a third embodiment of a knife in a first configuration in accordance with this disclosure.

FIG. 13 shows the knife of FIG. 12A in a second configuration.

FIG. 14 shows the knife of FIG. 12A in a third configuration.

FIG. 15 shows a fourth embodiment of a knife in a first configuration in accordance with this disclosure.

FIG. 16 shows the knife of FIG. 15 in a second configuration.

FIG. 17 shows a perspective view of the knife of FIG. 15 in the second configuration.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

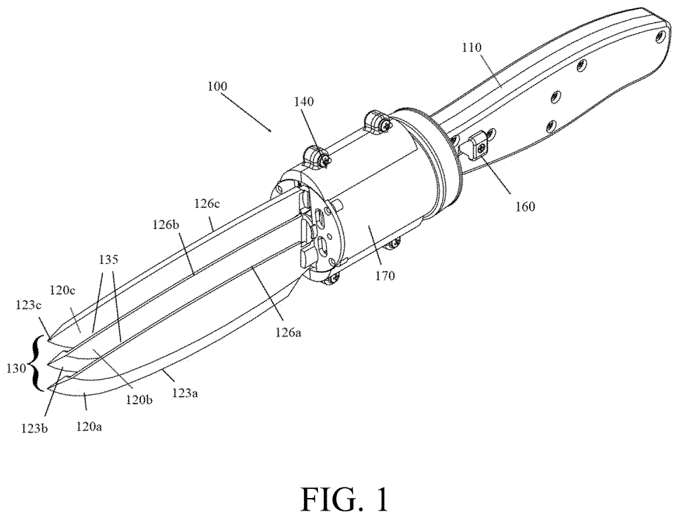

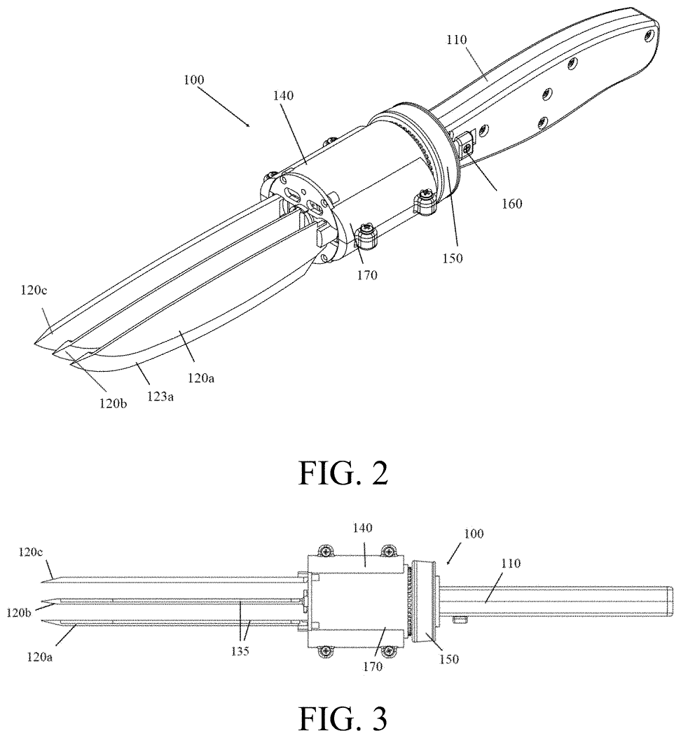

FIG. 1 shows a knife 100 in a first configuration and FIGS. 2 and 3 show the knife in a second configuration. The knife 100 comprises a handle 110 and a plurality of individual blades 120a-c movably fixed to the handle 110. The individual blades 120a-c are fixed to the handle 110 by way of a converter 140 that converts the knife from the first configuration to the second configuration and vice versa.

When in the first configuration, the knife 100 has a plurality of individual blades 120a-c that are substantially coplanar and form a combined blade 130. In the first configuration, portions of the blades 120a-c may overlap, which may in turn stabilize the combined blade. In the first configuration, the knife 100 may be used as a traditional knife with a single blade.

In the configuration shown, each knife blade 120a-c has a sharpened edge, 123a-c and a non-sharpened edge 126a-c. In some configurations, the non-sharpened edge 126a-c of each blade 120a-b may be provided with a seat 135 for a second blade 120b-c in order to stabilize the blades when they overlap. Accordingly, in the first configuration, the sharpened edge 123a of the first knife blade 120a functions as the knife blade for the combined blade 130.

The knife 100 also has the second configuration shown in FIGS. 2 and 3, wherein the plurality of individual blades 120a-c are positioned in distinct planes, typically parallel to each other. In the second configuration, the sharpened edge 123a-c of each blade 120a-c of the knife 100 may be used to cut multiple slices of a substance simultaneously. Where the individual blades 120a-c are parallel, the slices cut by the blade will be parallel as well.

In the embodiment shown, the knife 100 may be converted from the first configuration, shown in FIG. 1, to the second configuration, shown in FIGS. 2 and 3, by rotating the converter 140 relative to the handle 110. The knife 100 may further be provided with a lock 160 which must be released in order to allow the rotation of the converter 140.

Upon rotating the converter 140 or otherwise converting the knife 100 from the first configuration to the second configuration, each individual knife blade 120a-c are rotated about a respective rotational axis, the rotational axis running along a length of the corresponding individual blade. In the embodiment shown, the length of the knife handle 110 extends in parallel to the rotational axes of each of the individual blades 120a-c.

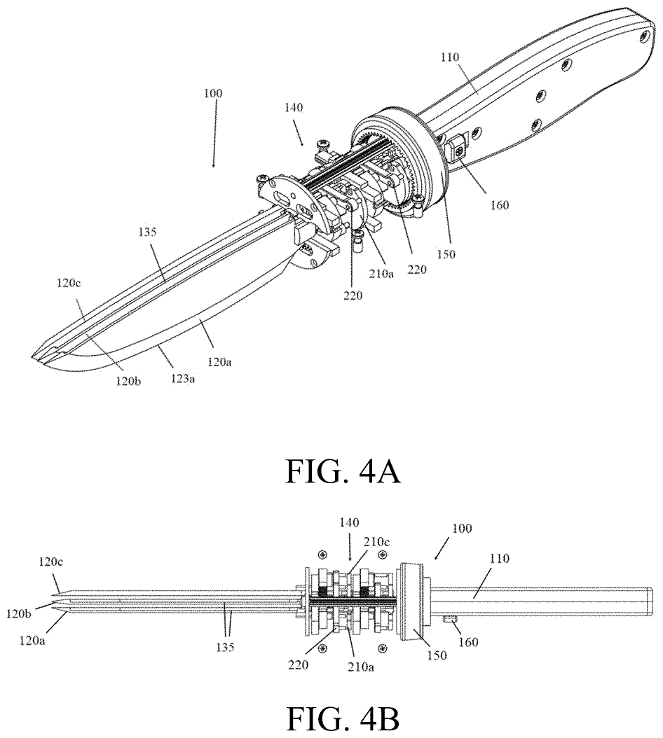

In addition to a converter 140 for converting the knife 100 from the first configuration to the second configuration, the knife 100 may be provided with an adjuster 150 for adjusting the space or angle between the blades 120a-c. FIGS. 4A and 4B show the knife 100 of FIG. 1 in a third configuration in which the individual blades 120a-c remain in distinct planes, typically parallel to each other, but they are spaced differently than in the second configuration. As shown, the blades 120a-c may be closer together, for example. Although the third configuration is shown with a housing 170 for the converter 140 removed, it will be understood that the housing may remain in place in each configuration.

The knife 100 may then be used to make parallel cuts simultaneously, where the cuts are farther apart than in the second configuration. In the embodiment shown, the knife 100 is provided with an adjuster 150 and may be transitioned from the second configuration to the third configuration by rotating the adjuster 150 relative to the converter 140. In some embodiments, the adjuster 150 will be required to be unlocked from the mechanism used to transition the knife 100 from the first configuration, shown in FIG. 1 to the second configuration, shown in FIG. 2, in order to allow for it to be used to transition between the second configuration and the third configuration, shown in FIGS. 4A and 4B. For example, it may be unlocked by pulling the adjuster 150 away from the converter 140.

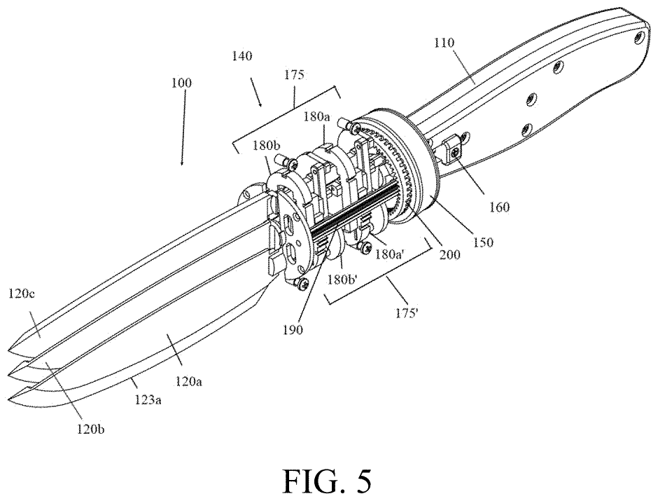

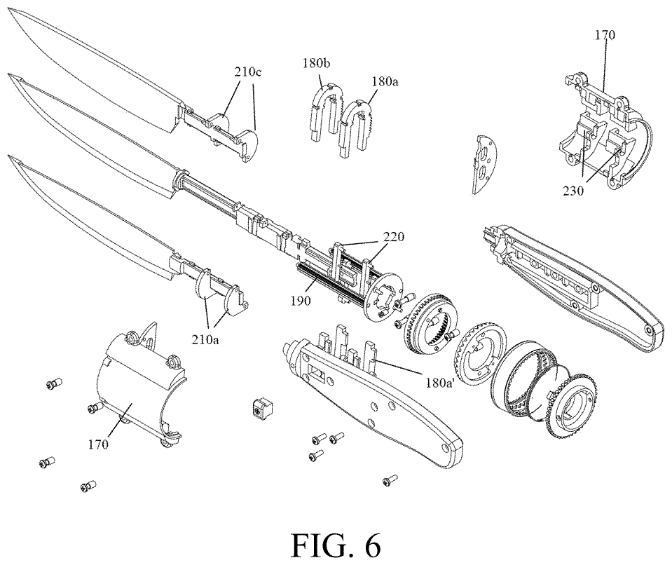

FIG. 5 shows the knife 100 of FIG. 1 with a housing 170 for the converter 140 removed and FIG. 6 shows an exploded version of the knife 100 of FIG. 1. As shown, the converter 140 has a housing 170 that houses a rack and pinion mechanism 175 visible from the top of the knife 100 comprising two racks 180a-b and a single pinion 190 crossing both of those racks. A parallel mechanism 175′ may be provided on the bottom of the knife with parallel components providing additional stability and applying required motion in an opposite direction. The rack and pinion mechanisms 175, 175′ control the transition from the second configuration to the third configuration. By rotating the pinions 190, 190′, the pinion engages the racks 180a-b, 180a-b′ and translates the plurality knife blades 120a-c relative to each other. By rotating in a first direction, the blades may be drawn closer together by drawing the racks towards the central blade, and by rotating in a second direction, the blades may be moved farther apart. As can be seen in FIG. 6, the first rack and pinion mechanism 175 applies the adjustments to the first blade 120a and the second mechanism 175′ applies opposite adjustments to the third blade 120c, with the second blade 120b remaining stable at a center point between those blades.

Also within the housing 170 is a rotational mechanism 200 that controls the transition of the knife 100 from the first configuration, shown in FIG. 1 to the second configuration shown in FIG. 2. Fixed to each of the first blade 120a and the third blade 120c is a pair of rotation plates 210a, 210c. These rotation plates are connected to each other by cross bars 220 and are retained by braces 230 on an interior of the housing 170. Accordingly, when the lock 160 releases the mechanism and the housing 170 is rotated, the rotation plates are revolved about a central axis along the second knife blade 120b while the attached knife blades 120a, 120c are held in an orientation parallel to each other and the central knife blade 120b. Accordingly, by rotating the housing 170 in a first direction, the knife 100 may be transitioned from the first configuration to the second configuration and by rotating the housing in a second direction, the knife may be transitioned from the second configuration to the first configuration.

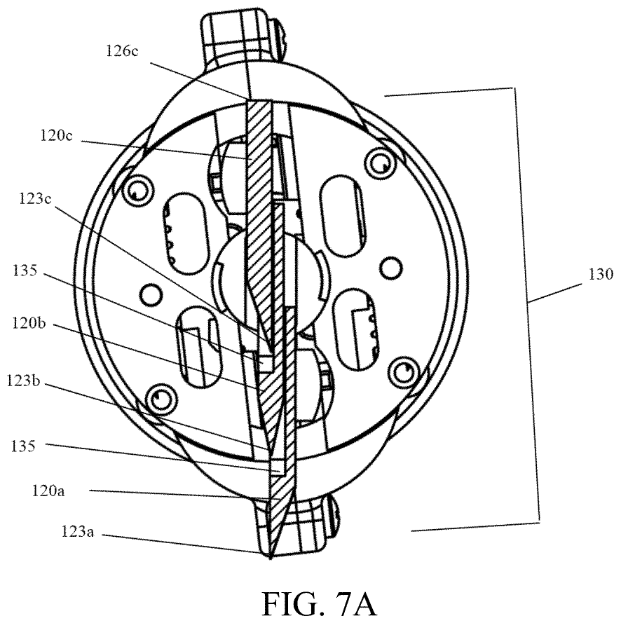

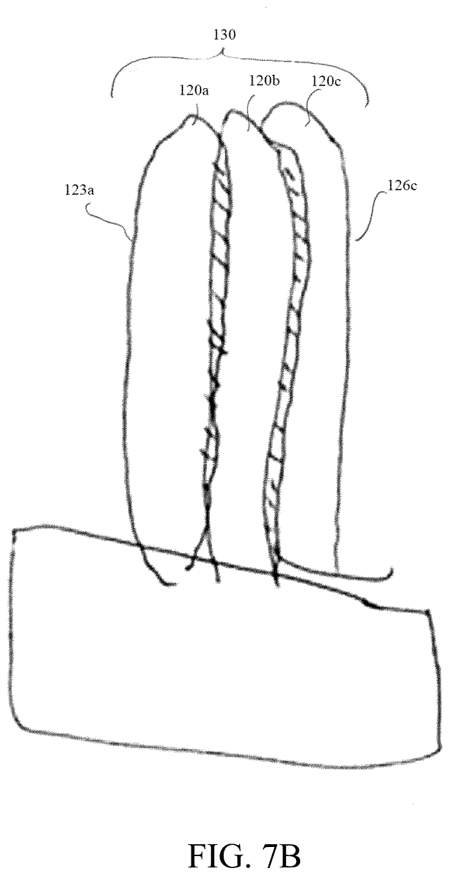

FIGS. 7A and 7B show a detail of the knife 100 of FIG. 1 in the first configuration. As shown, each blade 120a-c of the knife 100 may overlap the next blade, such that a single blade 130 is formed.

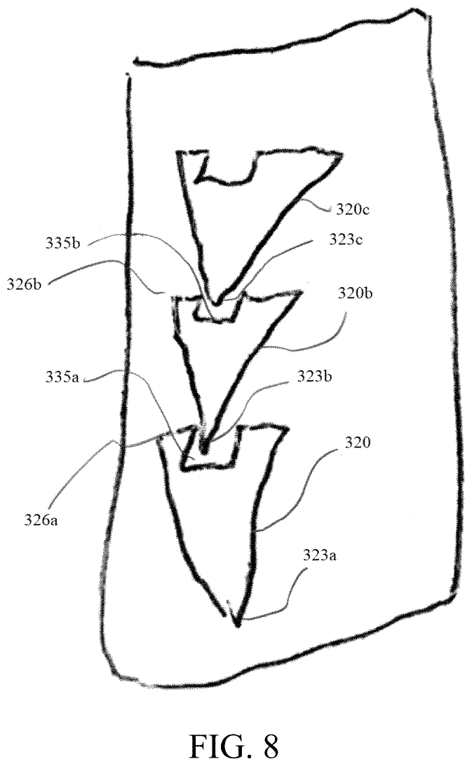

FIG. 8 shows a detail of a second embodiment of a knife in a first configuration having three knife blades 320a-c, with the blade edge 323a-c of each of a second and third knife blade 320b-c sitting in a seat 335a-b on the spine 326a-b of the first and second blade respectively.

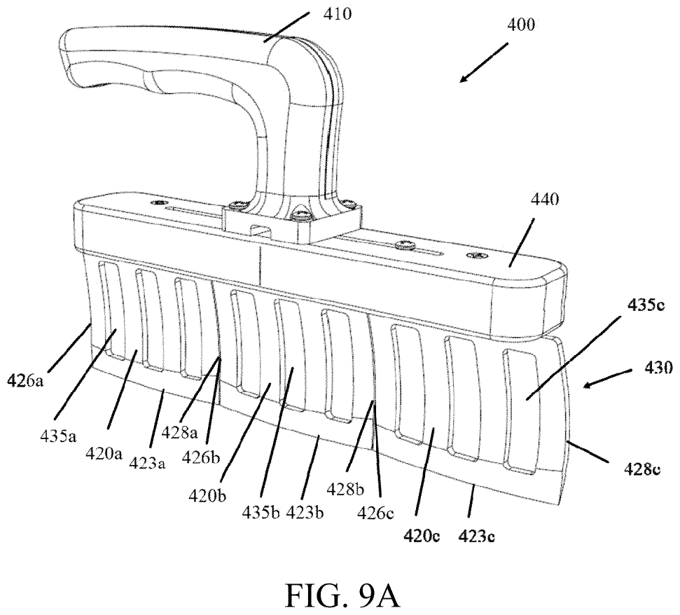

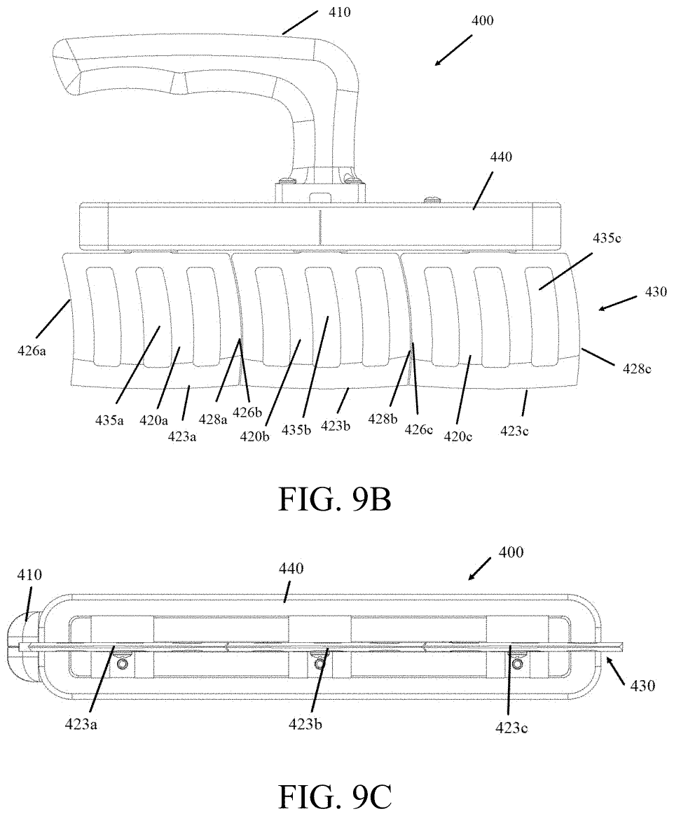

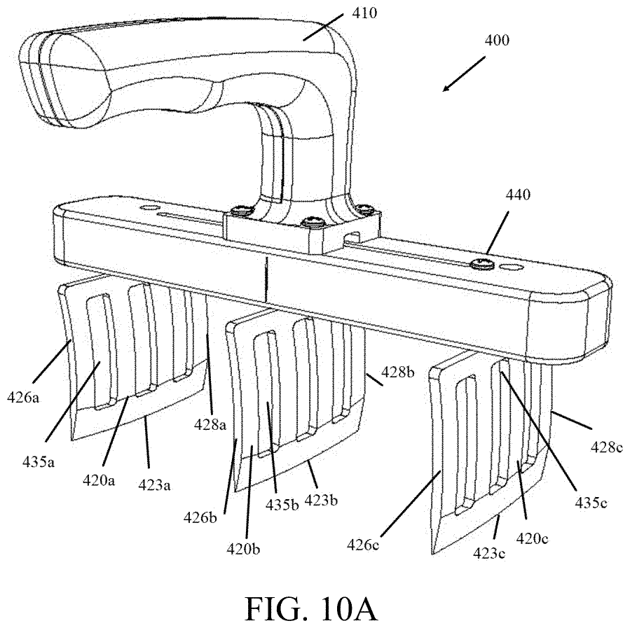

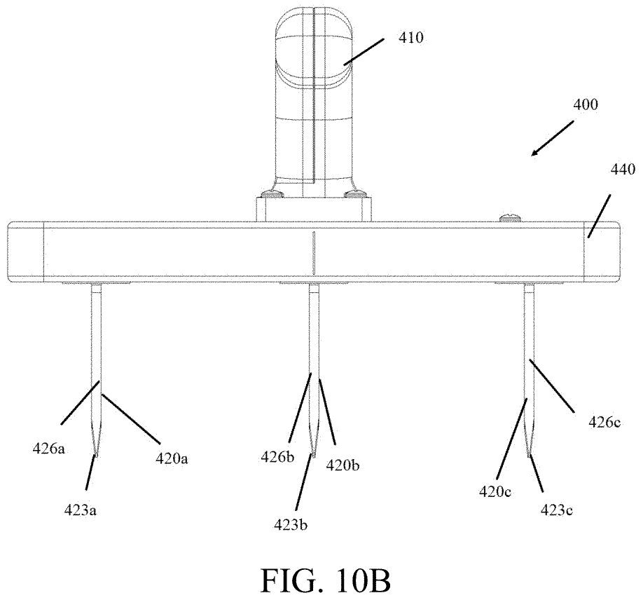

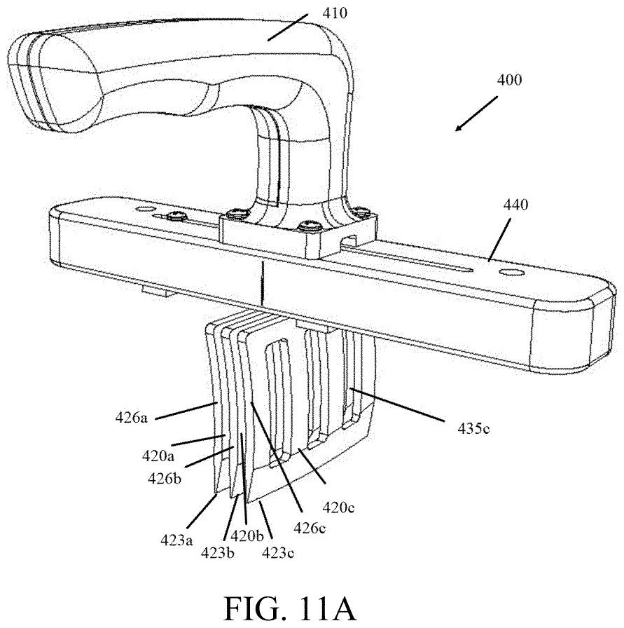

FIGS. 9A-9C show a second embodiment of a knife 400 in a first configuration and FIGS. 10A-10B show the second embodiment in a second configuration. As shown, the knife 400 comprises a handle 410 and a plurality of individual blades 420a-c movably fixed to the handle 410. The individual blades 420a-c are fixed to the handle 410 by way of a converter 440 that converts the knife from the first configuration to the second configuration and vice versa.

When in the first configuration, the knife 400 has a plurality of individual blades 420a-c that are coplanar and form a combined blade 430. Accordingly, in the first configuration, the knife 400 may be used as a traditional chopping knife with a single blade.

In the configuration shown, each knife blade 420a-c has a sharpened edge 423a-c. Accordingly, in the first configuration, the sharpened edges 423a of the three blades are configured linearly and together function as a combined blade 430.

In some embodiments, non-sharpened sides 426a-c, 428a-c of the knife blades 420a-c adjacent the sharpened edges 423a-c may be provided with curvature. As shown, the curvature of the second side 428a of the first blade 420a will complement the curvature of the first side 426b of the second blade 420b. Similarly, the curvature of the second side 428b of the second blade 420b will complement the curvature of the first side 426c of the third blade 420c. In this way, when the knife is in the first configuration, as shown in FIGS. 9A-9C, the blades 420a-c will fit together and brace securely against each other.

In some embodiments, the first and second sides 426a-c, 428a-c of the blades may be provided with projections and seats in order to further secure the blades in the first configuration. This is shown above with respect to the first embodiment.

As shown, the second embodiment may further comprise openings 435a-c extending through a thickness of each blade 420a-c. Such openings 435a-c may prevent objects being cut from sticking to the blade during use.

The knife 400 also has the second configuration shown in FIGS. 10A-10B, wherein the plurality of individual blades 420a-c are positioned in distinct planes, typically parallel to each other. In the second configuration, the sharpened edge 423a-c of each blade 420a-c of the knife 400 may be used to cut multiple slices of a substance simultaneously. Where the individual blades 420a-c are parallel, the slices cut by the blade will be parallel as well. Accordingly, the knife 400 when in the second configuration functions as a multiple blade chopping knife.

In the embodiment shown, the knife 400 may be converted from the first configuration, shown in FIGS. 9A-9C, to the second configuration, shown in FIGS. 10A-10B, by rotating the converter 440 relative to the handle 410. Upon rotating the converter 440 or otherwise converting the knife 400 from the first configuration to the second configuration, each individual knife blade 420a-c is rotated about a respective rotational axis of the corresponding individual blade. In the embodiment shown, the length of the sharpened edges 423a-c of the individual blades 420a-c is perpendicular to the rotational axis for the corresponding blade.

In the embodiment shown, the knife handle 410 extends in parallel to the sharpened edges 423a-c of the individual blades and is similarly perpendicular to the rotational axes of each of the individual blades 420a-c.

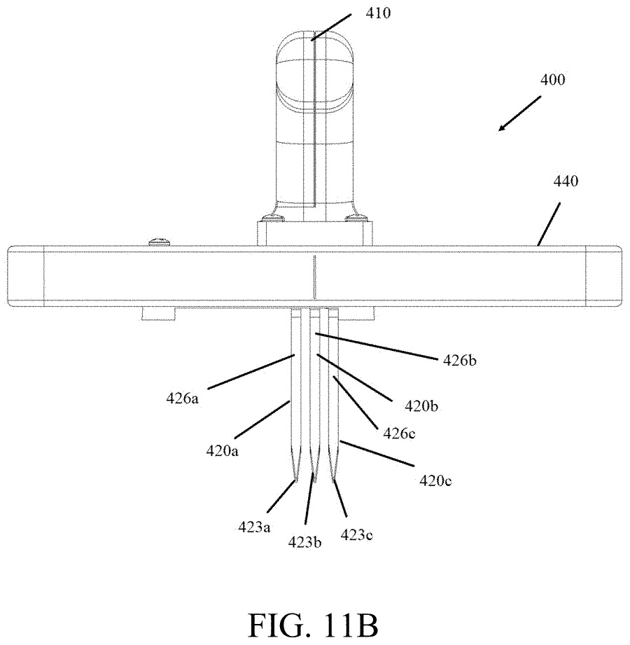

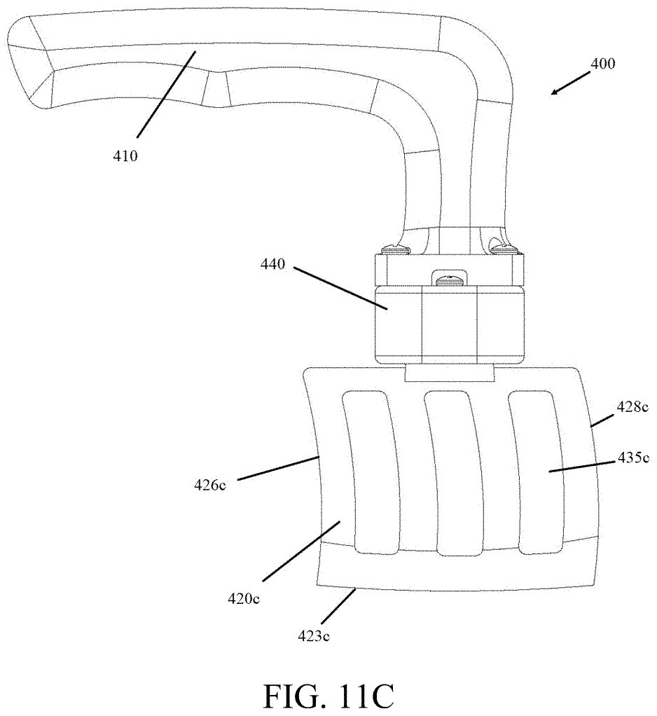

In addition to a converter 440 for converting the knife 400 from the first configuration to the second configuration, the knife 400 may be provided with an adjuster 450 for adjusting the space or angle between the blades 420a-c. FIGS. 11A-11B show the knife 400 of FIG. 9A in a third configuration in which the individual blades 420a-c remain in distinct planes, typically parallel to each other, but they are spaced differently than in the second configuration. As shown, the blades 420a-c may be closer together, for example.

The knife 400 may then be used to make parallel cuts simultaneously, where the cuts are closer together than in the second configuration.

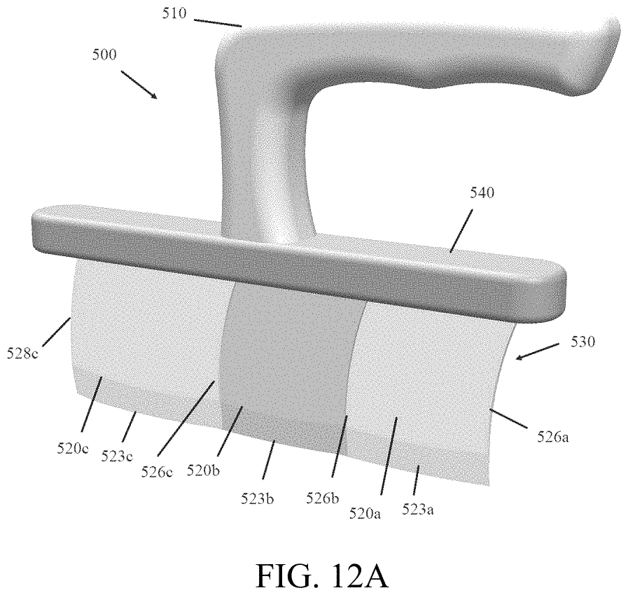

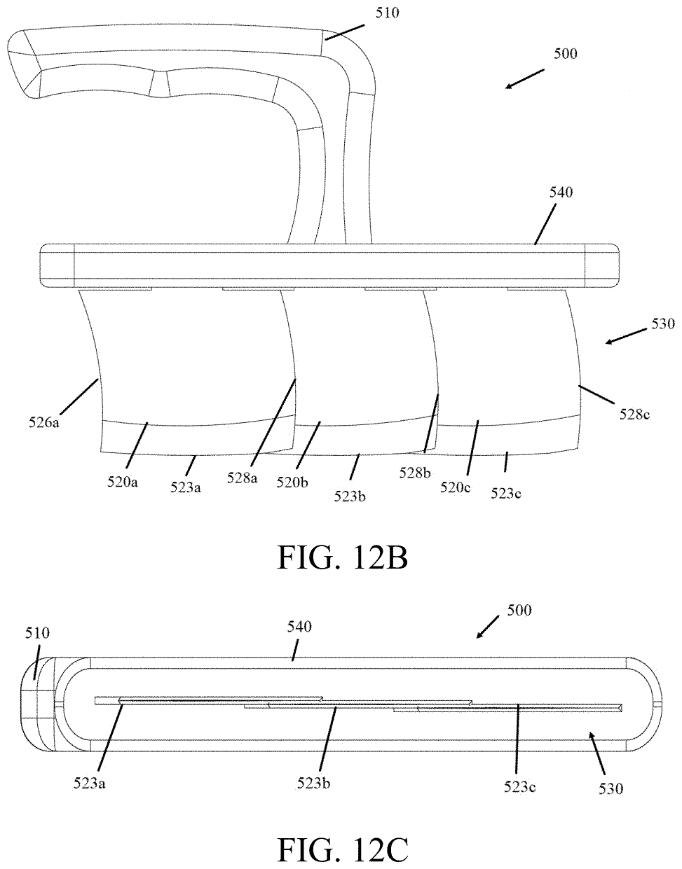

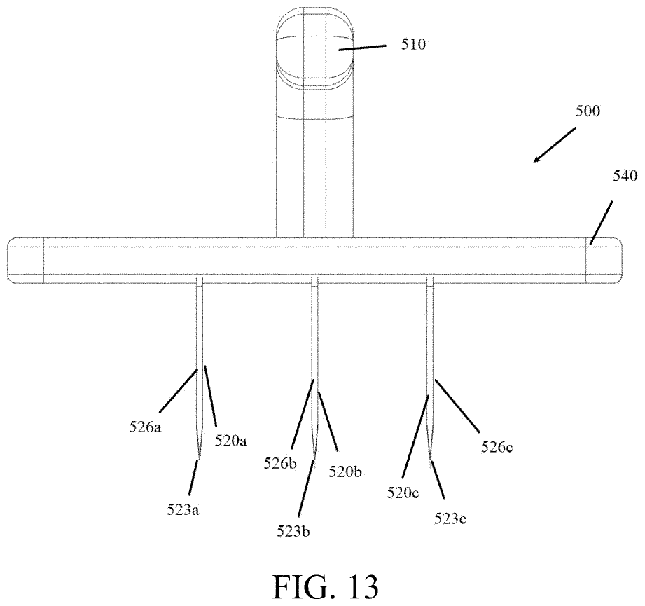

FIGS. 12A-12C show a third embodiment of a knife 500 in a first configuration and FIG. 13 show the third embodiment in a second configuration. As shown, the knife 500 comprises a handle 510 and a plurality of individual blades 520a-c movably fixed to the handle 510. The individual blades 520a-c are fixed to the handle 510 by way of a converter 540 that converts the knife from the first configuration to the second configuration and vice versa.

When in the first configuration, the knife 500 has a plurality of individual blades 520a-c that are substantially coplanar and form a combined blade 530. In the first configuration, portions of the blades 520a-c may overlap, which may in turn stabilize the combined blade. In the first configuration, the knife 500 may be used as a traditional chopper knife with a single blade.

In the configuration shown, each knife blade 520a-c has a sharpened edge 523a-c. Accordingly, in the first configuration, the sharpened edges 523a of the three blades are configured linearly and together function as a combined blade 530.

In some embodiments, non-sharpened sides 526a-c, 528a-c of the knife blades 520a-c adjacent the sharpened edges 523a-c may be provided with curvature. As shown, the curvature of the second side 528a of the first blade 520a may complement the curvature of the first side 526b of the second blade 420b. Similarly, the curvature of the second side 528b of the second blade 520b may complement the curvature of the first side 526c of the third blade 520c. In this way, when the knife is in the first configuration, as shown in FIGS. 12A-12C, the blades 520a-c may overlap each other, as noted above, but will overlap each other a consistent amount due to the complementary curvature.

In some embodiments, the second side 528a-c of each of the blades 520a-c may be provided with seats for retaining the overlapping portion of the first side 526a-c of the adjacent blade. This is shown above with respect to the first embodiment.

As shown, each individual blade 520a-c may be provided with some curvature in order to allow for a traditional chopping motion, including rocking the blades back and forth, when the blades are in the second configuration. Accordingly, the blades 520a-c each have a curved end segment and a substantially linear central segment. Accordingly, when the individual blades 520a-c combine to form a combined blade 530, the curvature is in the overlapping segments of the blade such that the exposed combined blade is substantially linear.

The knife 500 also has the second configuration shown in FIG. 13, wherein the plurality of individual blades 520a-c are positioned in distinct planes, typically parallel to each other. In the second configuration, the sharpened edge 523a-c of each blade 520a-c of the knife 500 may be used to cut multiple slices of a substance simultaneously. Where the individual blades 520a-c are parallel, the slices cut by the blade will be parallel as well. Accordingly, the knife 500 when in the second configuration functions as a multiple blade chopping knife.

In the embodiment shown, the knife 500 may be converted from the first configuration, shown in FIGS. 12A-12C, to the second configuration, shown in FIG. 13, by rotating the converter 540 relative to the handle 510. Upon rotating the converter 540 or otherwise converting the knife 500 from the first configuration to the second configuration, each individual knife blade 520a-c is rotated about a respective rotational axis of the corresponding individual blade. In the embodiment shown, the length of the sharpened edges 523a-c of the individual blades 520a-c is perpendicular to the rotational axis for the corresponding blade.

In the embodiment shown, the knife handle 510 extends in parallel to the sharpened edges 523a-c of the individual blades and is similarly perpendicular to the rotational axes of each of the individual blades 520a-c.

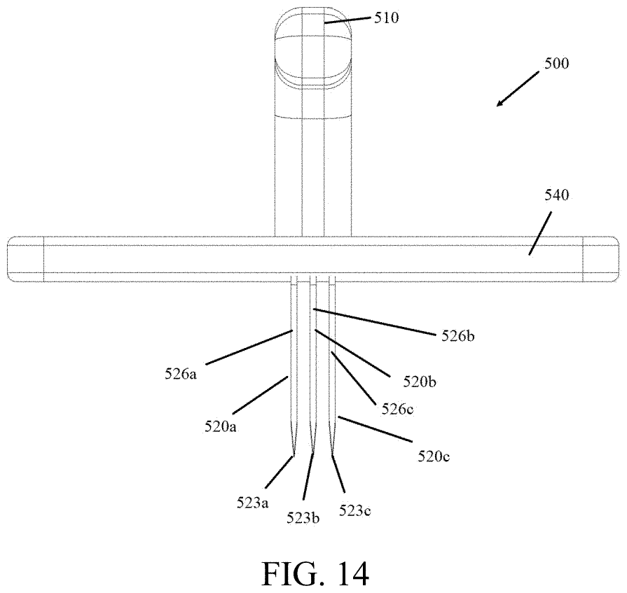

In addition to a converter 540 for converting the knife 500 from the first configuration to the second configuration, the knife 500 may be provided with an adjuster 550 for adjusting the space or angle between the blades 520a-c. FIG. 14 show the knife 500 of FIG. 12A in a third configuration in which the individual blades 520a-c remain in distinct planes, typically parallel to each other, but they are spaced differently than in the second configuration. As shown, the blades 520a-c may be closer together, for example.

The knife 500 may then be used to make parallel cuts simultaneously, where the cuts are closer together than in the second configuration.

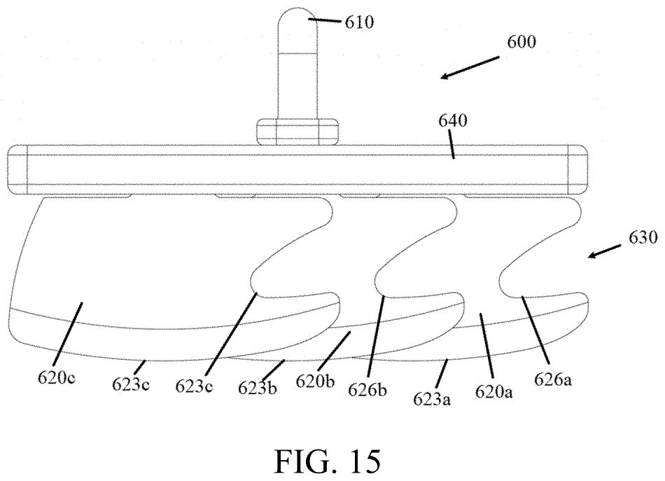

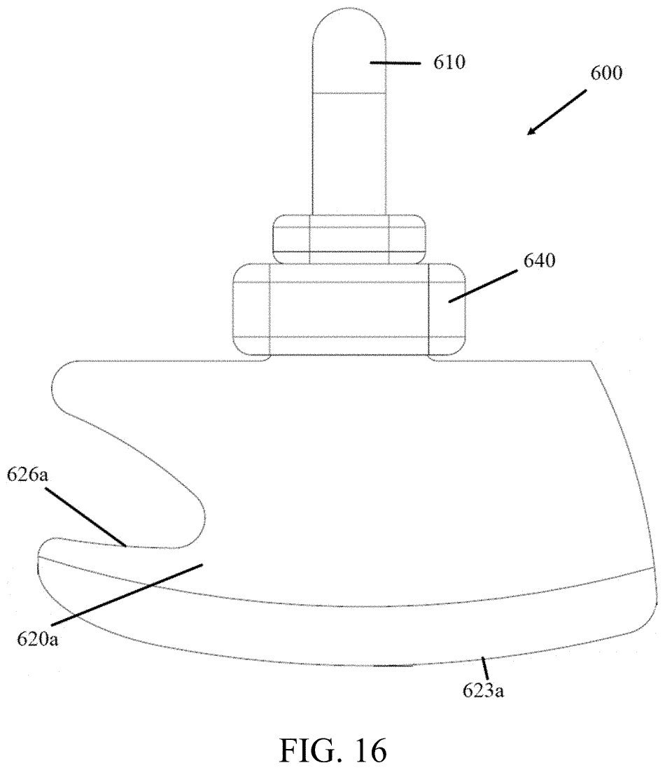

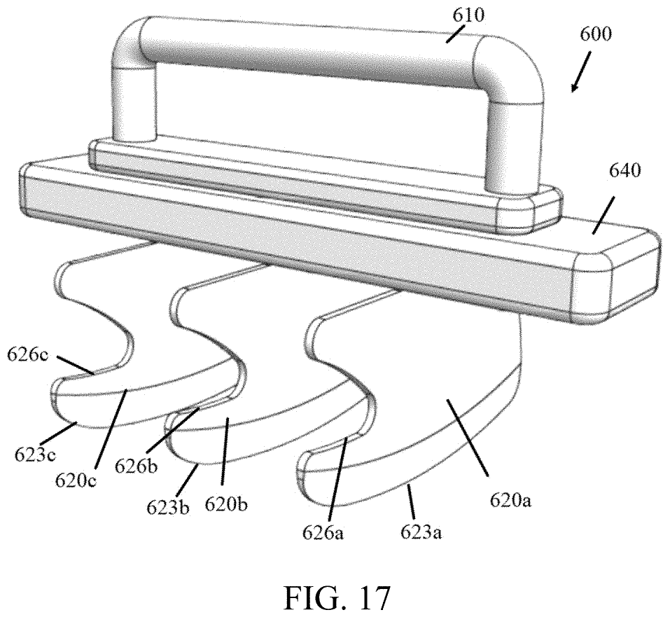

FIG. 15 shows a fourth embodiment of a knife 600 in a first configuration and FIGS. 16 and 17 show the fourth embodiment in a second configuration. A third configuration may be provided as well, with the space between the blades in the second configuration of the knife 600 being adjustable. As shown, the knife 600 comprises a handle 610 and a plurality of individual blades 620a-c movably fixed to the handle 610. The individual blades 620a-c are fixed to the handle 610 by way of a converter 640 that converts the knife from the first configuration to the second configuration and vice versa.

When in the first configuration, the knife 600 has a plurality of individual blades 620a-c that are substantially coplanar and form a combined blade 630. In the first configuration, portions of the blades 620a-c may overlap, which may in turn stabilize the combined blade. In the first configuration, the knife 600 may be used as a traditional chopper knife with a single blade.

In the configuration shown, each knife blade 620a-c has a sharpened edge 623a-c. Accordingly, in the first configuration, the sharpened edges 623a of the three blades are configured substantially linearly and together function as a combined blade 630.

As shown, and as is seen more clearly in the second configuration shown in FIG. 16, one non-sharpened side of each blade 620a-c may be provided with a curvature 626a-c forming a hook. Such a hook may, in some example, be sharpened, and may provide various functions. For example the hook 626a-c of each blade 620a-c may be functional as a gut hook. When the knife is in the first configuration, as shown in FIG. 15, the blades 620a-c may overlap each other to form a single combined blade 630. Such a single continuous combined blade 630 may have a substantially continuous curvature despite the distinct curvature of the individual blades 620a-c due to the overlapping edges.

The knife 600 also has the second configuration shown in FIGS. 16 and 17, wherein the plurality of individual blades 620a-c are positioned in distinct planes, typically parallel to each other. In the second configuration, the sharpened edge 623a-c of each blade 620a-c of the knife 600 may be used to cut multiple slices of a substance simultaneously. Where the individual blades 620a-c are parallel, the slices cut by the blade will be parallel as well. Accordingly, the knife 600 when in the second configuration functions as a multiple blade chopping knife.

In the embodiment shown, the knife 600 may be converted from the first configuration, shown in FIG. 15, to the second configuration, shown in FIGS. 16 and 17, by a mechanism in the converter 640. Such a mechanism may be activated by rotating the knife handle 610 relative to the converter 640. Upon converting the knife 600 from the first configuration to the second configuration, each individual knife blade 620a-c is rotated about a respective rotational axis of the corresponding individual blade. In the embodiment shown, the length of the sharpened edges 623a-c of the individual blades 620a-c is perpendicular to the rotational axis for the corresponding blade.

In the embodiment shown, the knife handle 610 is perpendicular to the sharpened edges 623a-c of the individual blades in both configurations, and is similarly perpendicular to the rotational axes of each of the individual blades 620a-c.

In other respects, the knife shown in FIGS. 15-17 may be similar to the embodiment shown in FIG. 12A.

While the figures show the internal mechanism for the knife embodiment shown in FIGS. 1A-8, the mechanism described may also be incorporated into the chopper embodiments shown in FIGS. 9A-17 such that a chopper may be provided with the coextensive blades forming a single blade in configuration shown in FIGS. 9A, 12A, and 15 and with distinct blades arranged in parallel, in a second configuration, shown in FIGS. 10A, 13, and 17. As shown, in such a chopper configuration, a length of a handle of the chopper may extend in a direction perpendicular to the rotational axes of the individual blades.

Further, while the figures shown provide a knife with three blades combining to form a single blade, additional configurations are contemplated in which additional blades are provided, such that the single blade 130, 430, 530, 630 comprises four or more individual blades.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. A knife comprising:
a handle; and
a plurality of individual blades movably fixed to the handle,
wherein the plurality of individual blades has a first configuration, wherein the plurality of individual blades are in distinct planes and a second configuration, wherein the plurality of individual blades are substantially coplanar and form blade portions of a combined blade,
wherein each of the individual blades transition from the first configuration to the second configuration by rotating about a respective rotational axis.

2. The knife of claim 1 wherein the distinct planes are parallel.

3. The knife of claim 1 wherein each of the individual blades has a width and the total width of the combined blade is less than the sum of the widths of the individual blades.

4. The knife of claim 3 wherein segments of the individual blades are coextensive when they form the combined blade.

5. The knife of claim 1 wherein the distinct parallel planes are spaced apart.

6. The knife of claim 1 wherein the individual blades are translatable relative to each other when in the first configuration, such that the amount by which the distinct planes are spaced apart is adjustable.

7. The knife of claim 1 wherein the handle has a length extending perpendicular to the rotational axes of the individual blades.

8. The knife of claim 1 wherein the rotational axes translate relative to each during the transition from the first configuration to the second configuration.

9. The knife of claim 1 wherein, in the second configuration, the plurality of individual blades abut each other and the individual blades are coplanar.

10. The knife of claim 9 wherein each of the plurality of individual blades have a substantially linear sharpened edge and has at least one curved side adjacent the sharpened edge, and wherein, when in the second configuration, the curvature of a first side of a first of the plurality of individual blades complements the curvature of a second side of a second of the plurality of individual blades.

11. The knife of claim 1 wherein, in the second configuration, the plurality of individual blades partially overlap.

12. The knife of claim 11 wherein each of the plurality of individual blades has a sharpened edge, and wherein the sharpened edge has a substantially linear central portion and has a curved section at an end.

13. The knife of claim 12 wherein the partial overlap of the plurality of individual blades in the second configuration extends across the curved section of the corresponding sharpened edge.

14. The knife of claim 1 wherein each of the plurality of individual blades has a sharpened edge, and wherein the sharpened edge of each of the individual blades is perpendicular to the rotational axis of the corresponding blade.
